(19) United States
(12) Patent Application Publication
(10) Pub. No.: US 2005/0182503 A1
(43) Pub. Date: Aug. 18, 2005

(54) System and method for the automatic and semi-automatic media editing

(76) Inventors: Yu-Ru Lin, Tao-Yuan (TW); Shu-Fang Hsu, Taipei City (TW); Chun-Yi Wang, Taipei City (TW)

Correspondence Address: BIRCH STEWART KOLASCH & BIRCH, PO BOX 747, FALLS CHURCH, VA, 22040-0747, US

(21) Appl. No.: 10/776,530

(22) Filed: Feb. 12, 2004

(51) Int. Cl. G06F 17/00

(52) U.S. Cl. 700/94

(57) ABSTRACT

A method and system of media editing is provided. First, there are audio data with descriptors and visual data with descriptors. According to different types of associated audio descriptors, different correlating process is selected for correlating the audio data and visual data with respective descriptors. According to a correlating solution found by the correlating process, the audio data and visual data with respective descriptors are adjusted to generate a media output in accordance with significant visual change or audio change.

### BACKGROUND OF THE INVENTION

1. Field of the Invention

The present invention generally relates to system and method for computer generating media production and more particularly to a system and a method for the automatic and semi-automatic media editing.

2. Description of the Prior Art

Widespread proliferation of personal video cameras has resulted in an astronomical amount of uncompelling home video. Many personal video camera owners accumulate a large collection of videos documenting important personal or family events. Despite their sentimental value, these videos are too tedious to watch. There are several factors detracting from the watch ability of home videos.

First, many home videos are comprised of extended periods of inactivity or uninteresting activity, with a small amount of interesting video. For example, a parent videotaping a child's soccer game will record several minutes of interesting video where their own child makes a crucial play, for example scoring a goal, and hours of relatively uninteresting game play. The disproportionately large amount of uninteresting footage discourages parents from watching their videos on a regular basis. For acquaintances and distant relatives of the parents, the disproportionate amount of uninteresting video is unbearable.

Second, the poor sound quality of many home videos exacerbates the associated tedium. Well-produced home video will appear amateurish without professional sound recording and post-production. Further, studies have shown that poor sound quality degrades the perceived video image quality. In W. R. Neuman, “Beyond HDTV: Exploring Subjective Responses to Very High Definition Television, “MIT Media Laboratory Report, July 1990, listeners judged identical video clips to be of higher quality when accompanied by higher-fidelity audio or a musical soundtrack.

Thus, it is desirable to condense large amounts of uninteresting video into a short video summary. Tools for editing video are well known in the art. Unfortunately, the sophistication of these tools make it difficult to use for the average home video producer. Further, even simplified tools require extensive creative input by the user in order to precisely select and arrange the portions of video of interest. The time and effort required to provide the creative input necessary to produce a professional looking video summary discourages the average home video producer.

Referring to FIG. 1, input signal 101 includes one or more pieces of media, which is presented as an input to the system. Supported media types include video, image, slideshow, music, speech, sound effects, animation and graphics.

Analyzer 102 includes video analyzer, soundtrack analyzer, and image analyzer. The analyzer 102 measures of the rate of change and statistical properties of other descriptors, descriptors derived by combining two or more other descriptors, etc. For example, the video analyzer measures the probability that the segment of an input video contains a human face, probability that it is a natural scene, etc. The soundtrack analyzer measures audio intensity or loudness, frequency content such as spectral centroid, brightness and sharpness, categorical, rate of change and statistical properties. In short, the analyzer 102 receives input signal 101 and outputs descriptors which describe features of input signal 101.

Constructor 103 receives one or more descriptors from the analyzer 102 and the style information 104 for outputting an edit decisions signal.

Render 105 receives raw data from the input signal 101, and an edit decisions signal from constructor 103 and outputs an edited media production 106.

The feature here is the constructor 103 receives one or more descriptors and style information for generating an edit decisions signal. And the edit decisions signal can be regarded as a complete instructions and it determines which raw data would be chosen. It is noted that the analyzer 102 only outputs descriptors and the constructor 103 also only combines the descriptors and style information. The steps maybe use a difficult and complex algorithm, such as tree method, however it outputs an edit decisions signal for editing the raw data, and this method maybe re-arrange the sequence of the original input production.

### SUMMARY OF THE INVENTION

A system and method for automatic and semi-automatic media editing is provided for media output in accordance with visual change or audio change.

One reason of this invention involves a method for automatic and semi-automatic editing. Based on different types of audio descriptors, the respective correlating method of audio and visual inputs is executed, thus a media production is acquired with better quality.

A method and system of media editing is provided. First, there are audio data with descriptors and visual data with descriptors, in which audio descriptors comprise segmenting information or changing index. Based on different types of audio descriptors, different correlating process is selected for correlating the audio data and visual data with respective descriptors. According to a correlating solution found by the correlating process, the audio data and visual data with respective descriptors are adjusted to generate a media output in accordance with significant visual change or audio change.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic block diagram illustrating a media editing system according to one prior art;

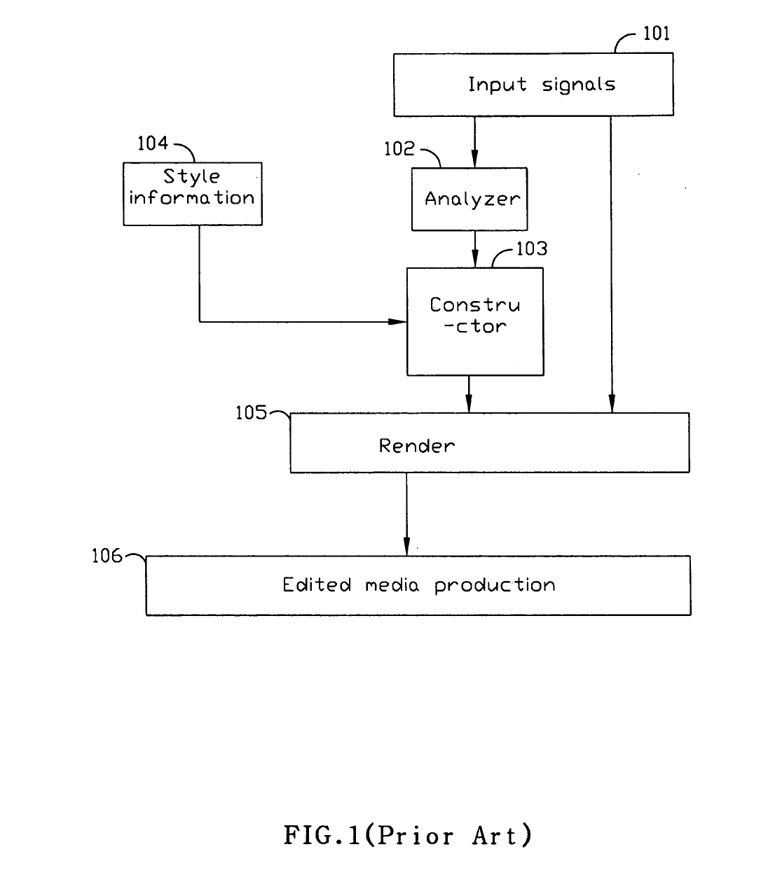

FIG. 2 is a schematic block diagram illustrating a media editing system in accordance with this invention;

FIG. 3 is a schematic block diagram illustrating a media editing system of one embodiment in accordance with this invention;

FIG. 4 is a schematic flow chart in accordance with FIG. 3;

FIG. 5 is a schematic block diagram illustrating one embodiment of audio-based correlating process in accordance with the present invention;

FIG. 6 is a schematic flow chart in accordance with FIG. 5;

FIG. 7 is a schematic block diagram illustrating one embodiment of visual-based correlating process in accordance with the present invention;

FIG. 8 is a schematic diagram illustrating one embodiment of visual-based correlating process in accordance with the present invention; and

FIG. 9 is a schematic flow chart in accordance with FIG. 7.

### DESCRIPTION OF THE PREFERRED EMBODIMENTS

Before describing the invention in detail, a brief discussion of some underlying concepts will first be provided to facilitate a complete understanding of the invention.

A fact is a truism in the film industry, and has been affirmed in a number of studies. One study at MIT (Massachusetts Institute of Technology, U.S.) showed that listeners judge the identical video image to be higher quality when accompanied by higher-fidelity audio.

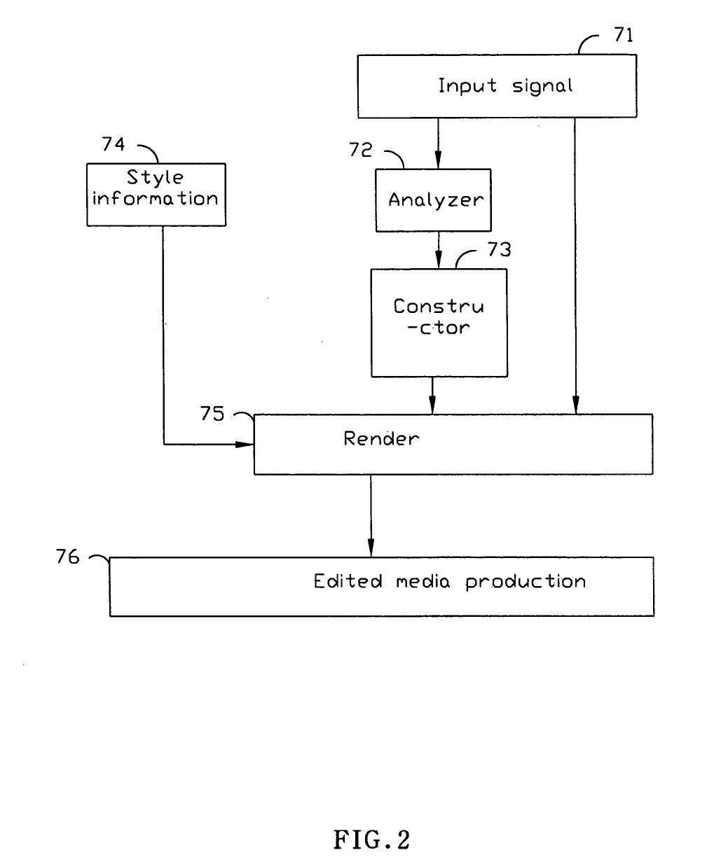

Referring to FIG. 2, Input signal 71 includes one or more pieces of media, which is presented as an input to the system. Supported media types, without limitation, include video, image, slideshow, music, speech, sound effects, animation and graphics.

Analyzer 72 includes visual analyzer, and audio analyzer. The analyzer 72 extracts the information embedded in media content, like time-code, duration of media, and measures the rate of change and statistical properties of other descriptors, descriptors derived by combining two or more other descriptors, etc. For example, the visual analyzer measures the probability that a segment of the input video contains a human face, probability that it is a natural scene, etc. The audio analyzer measures audio intensity or loudness, frequency content such as spectral centroid, brightness and sharpness, categorical, rate of change and statistical properties. In short, the analyzer 72 receives input signal 71 and outputs descriptors, which describes features of input signal 71.

Constructor 73 receives one or more descriptors from the analyzer 72 for outputting an edit decisions signal.

Render 75 receives raw data from the input signal 71, an edit decisions signal from constructor 73, and style information 74 for rending them. One of features in one embodiment is that the complexity during constructor 73 can be reduced without addition of style information 74. Next, edited media production 76 is configured for editing media output from render 75. All blocks are described in detail as follows.

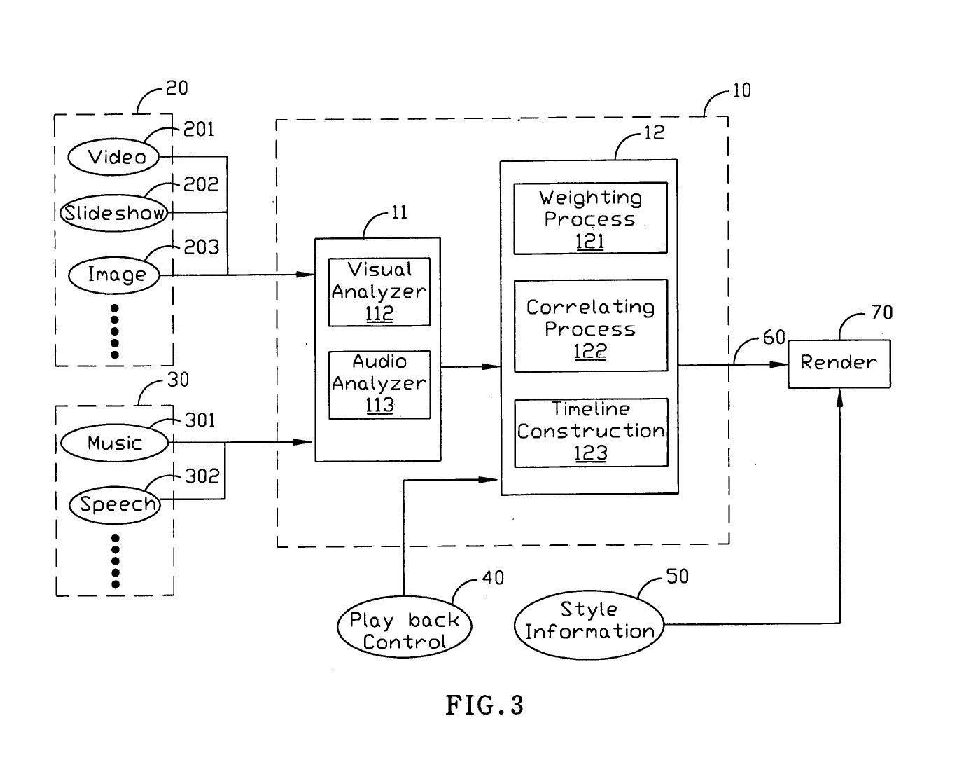

FIG. 3 is a schematic block diagram illustrating a media editing system of one embodiment in accordance with this invention. First, the media editing system 10 receives visual input signals 20, audio input signals 30 and playback controls 40, and generates media output 60. The term “visual input signal” refers to input signal of any visual type including video, slideshow, image, animation, and graphics, and inputs as a digital visual data file in any suitable standard format, such as DV video format. In an alternate embodiment, an analog visual input signal may be converted into a digital visual input signal used in the method. The term “audio input signal” refers to input signal of any audio type including music, speech and sound effects, and inputs as a digital audio data file in any suitable standard format, such as MP3 format. In an alternate embodiment, an analog audio input signal may be converted into a digital audio input signal used in the method.

In one embodiment, visual input signals 20, not limited, include video input 201, slideshow 202, image 203, etc. In the embodiment, video input 201 is typically unedited raw footage of video, such as video captured from a camera or camcorder, motion video such as a digital video stream or one or more digital video files. Optionally, it may include an audio soundtrack. In an embodiment, the audio soundtrack, such as people dialogue, is recorded simultaneously with the video input 201. Slideshow 202 refers to a visual signal including an image sequence and property. Images 203 are typical still images such as digital image files, which are optionally used in addition to motion video.

On the other hand, audio input signals 30 include music 301 and speech 302. In the embodiment, music 301 is in a form such as a digital audio stream or one or more digital audio files. Typically, music 301 provides the timing and framework for media output 60.

In addition to visual input signals 20 and audio input signals 30, other constrains, such as playback control 40, may be inputted into media editing system 10 for good quality media output 60.

Next, media editing system 10 includes analysis unit 11 and constructing unit 12. In one embodiment, analysis unit 11 is configured for generating analyzed data and descriptors 114 by analyzing visual input signals 20 and audio input signals 30. Furthermore, analysis unit 11 is configured for segmenting visual input signals 20 and audio input signals 30 according to visual or audio characteristics thereof.

In the embodiment, visual input signals 20 are analyzed and segmented by visual analyzer 112 for generating analyzed visual data and descriptors. In visual analyzer 112, visual input signals 20 are first parameterized by any typical methods, such as frame-to-frame pixel difference, color histogram difference, and low order discrete cosine coefficient difference. Then visual signals 20 are analyzed for acquiring analyzed descriptors. Typically, various analysis methods to detect segment boundary are used in visual analyzer 112, such as scene change detection, checking similarity of video frames, analyzing qualities of video segments (i.e. over-exposure, under-exposure, brightness, contrast, etc.), determining the importance of video segments, checking skin color and detecting faces, etc. The analyzed descriptors in visual analyzer 112 include typically measures of brightness or color such as histograms, measures of shape, or measures of activity. Furthermore, the analyzed descriptors include durations, qualities, importance and preference descriptors for the analyzed visual data. Then, the segmentation performed by visual analyzer 112, for example, is based on scene change detection to improve visual segmentation result and generates one or more visual segments. The visual segment is a sequence of video frames or a part of a clip that is composed one or more shots or scenes.

Furthermore, audio input signals 30 are analyzed by audio analyzer 113 for generating analyzed audio data and descriptors. In an alternate embodiment, audio input signals 30 are segmented by audio analyzer 113. The segmentation performed by audio analyzer 113, for example, is based on delimiting time periods with similar sound to explore the similarity of the audio track of different segments. The audio segment is a part of audio sample sequence that is composed similar audio pattern, where the segment boundary within two audio segments indicates the significant audio change such as a musical instrument onset, chord change, or beating. The analyzed descriptors in audio analyzer 113 include typically, measures of audio intensity or loudness, measures of frequency contents such as spectral centroid, brightness and sharpness, categorical likelihood measures, or measures of the rate of change and statistical properties of other analyzed descriptors.

In an alternative embodiment, audio input signals 30 are analyzed for finding audio change indices. The term “audio change indices” refers to the value that indicates the possibility of significant audio change in the audio input signals 30, such as beat onset, chord change, and others. In the embodiment, the audio change indices measured for audio input signals 30 may be computed by using any suitable analysis method and represented as the diagram of pitches versus time.

It is noted that visual input signals 20 with MPEG 7 format contains some visual descriptions, such as measure of color including scalable, color layout, dominant color, and measure of motion including motion trajectory and motion activity, camera motion and face recognition, etc. With the descriptions derived from one file in MPEG 7 format, such visual input signals 20 may be used for further process, instead of process of analysis unit 11. Accordingly, the descriptions derived from the file in MPEG 7 format would be utilized as analyzed visual descriptors mentioned in the following methods.

Similarly, audio input signals 30 with MPEG 7 format may provide the descriptions utilized as analyzed audio descriptors mentioned in the following method.

Next, analyzed data and descriptors 114 output to constructing unit 12 for synchronizing analyzed visual and audio data in accordance with analyzed visual and audio descriptors. Constructing unit 12 is configured for correlating the analyzed visual and audio data in sequence and time that both visual and audio change synchronously. Optionally, constructing unit 12 synchronizes analyzed visual and audio data with playback control 40. In an alternate embodiment, constructing unit 12 includes weighting process 121, correlating process 122 and timeline construction 123. Weighting process 121 is configured for determining the weight for visual data according to the evaluation of analyzed descriptors to decide the selecting priority of the analyzed data or for other application. Correlating process 122 is configured for selecting a correlating process to correlate the audio data and visual data with respective descriptors. In alternate embodiment, correlating process 122 provides two correlating processes: audio-based correlating process and visual-based correlating process. The former is considered audio input signal change prior to visual input signal change, and the later is considered visual input signal change prior to audio input signal change. Next, timeline construction 123 is configured for adjusting analyzed data according to the correlating solution from correlating process 122, so as to generate media output 60.

Normally, media output 60 would be directly viewed and run by users. Of course, with style information template 50, media output 60 would input into render unit 70 for post processing. In the embodiment, style information 50 is a defined project template, without limitation, which includes descriptors as follows: filters, transition effects, transition duration, title, credit, overlay, beginning video clip, ending video clip, and text. Furthermore, based on the selection of synchronization on prior consideration of audio input signal change, media output 60 would be played in accordance with audio change. In alternate embodiment, based on the selection of synchronization on prior consideration of visual input signal change, media output 60 would be played in accordance with visual change.

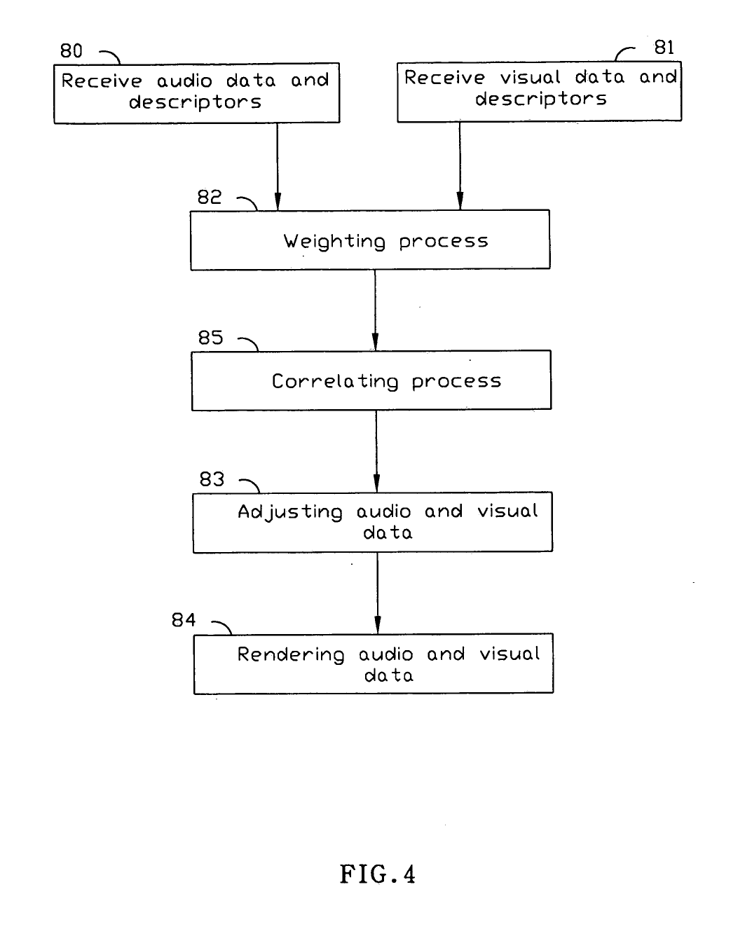

FIG. 4 is a schematic flow chart in accordance with FIG. 3. First, audio data and descriptors (step 80), and visual data and descriptors (step 81) are received. Next, a weighting and correlating process is selected and executed (step 82 and 85) for audio data and visual data. Then audio data and visual data are adjusted to generate a media output (step 83). Finally, the media output is rendered with other factors (step 84).

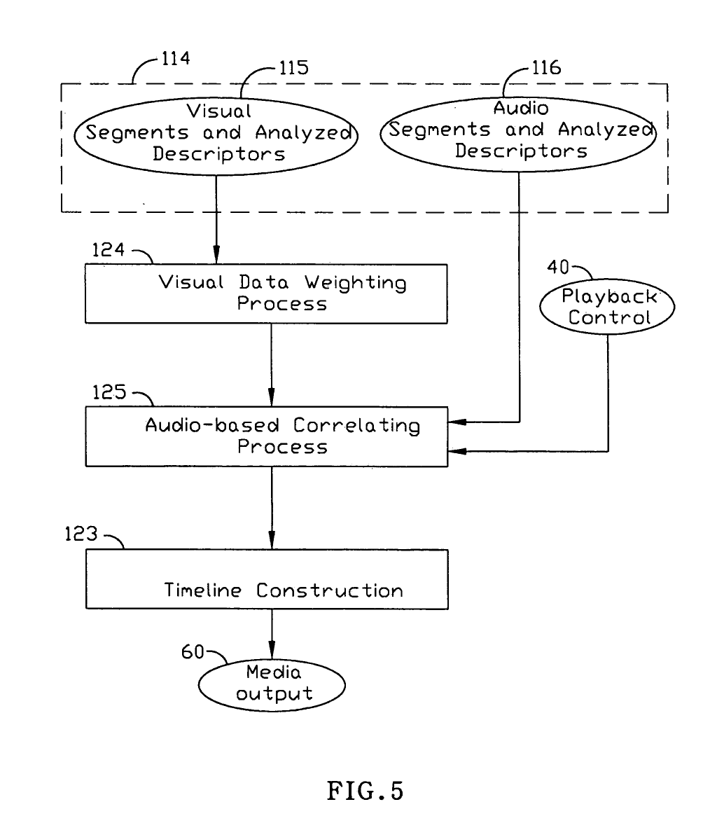

FIG. 5 is a schematic block diagram illustrating one embodiment of audio-based correlating process in accordance with the present invention. Refer to FIG. 5, analyzed data and descriptors 114 includes visual segments with analyzed descriptors 115 and audio segments with analyzed descriptors 116. Visual data weighting process 124 in weighting process 121 receives visual segments with analyzed descriptors 115 and calculates weights for each of visual segment on consideration of qualities, importance and preferences of visual segment. For instance, the slideshow and image maybe have a higher weighting value because users intent to show something important and they made them. Contrary to this, the unsteady video and unclear image get a lower weighting value. Furthermore, visual data weighting process 124 may estimate duration of each visual segment based on visual weights and further adjust visual segments by dropping the less significant frames or segments, or repeating partial segments based on the duration of audio input signals 30. Dropping the segments occurs when the duration of total visual segments is longer than the duration of audio segments. Repeating visual segments means if the total visual segments are not as long as audio segments, the visual segments will repeat its segments to correlate the total duration of audio input signals 30. The weight of a segment represents the importance or quality of the segment, and also determines the priority of repeating and dropping.

Next, for media output 60 played in accordance with audio change, audio-based correlating process 125 is selected. Firstly, a table is built with a first string, for example, consisting of the visual segments, along the horizontal axis, and a second string, for example, consisting of the audio segments, along the vertical axis. In the table, there is a column corresponding to each element of the first string and a row for each element of the second string. Furthermore, each visual segment “Vⱼ” is with corresponding visual weighting value “W(Vⱼ)” and visual duration “D(Vⱼ)” and each audio segment “Aᵢ” is with corresponding audio duration “D(Aᵢ)”. In an alternate embodiment, Vⱼ is a visual segment segmented by detecting visual input signals' significant change. Furthermore, audio input signals' change is considered prior to visual signals' change in this embodiment. In an alternate embodiment, there is a third string of playback control 40 consisting of, for example, each playback speed “P(Tᵢ)” along the second string. Storing and starting with the first element “T_{i,j}” in the first column (i=0), a score “S(T_{i,j})” respective to “T_{i,j}” is calculated as follows:
S(T_{i,j})=S(T_{i,j})=W(Vⱼ)*D(T_{i,j})/P(Tᵢ) for i=0, j=0 to m−1, m is the number of visual segments, where D(T_{i,j}) is the duration that visual segment Vⱼ actually spends in each element Tᵢ of row. That is, D(T_{i,j}) is the duration of Vⱼ respective to Aᵢ, the duration of Tᵢ is determined by Aᵢ more than by Vⱼ.

Once all the evaluations have been computed for the first column, the score S(T_{i,j}) for the second column “i=1” are computed. In the second column, each score S(T_{i,j}) is calculated as follows:
S(T_{i,j})=Max{S(T_{p,q})+S(T_{i,j})} for i>0, j=0 to m−1, i−1p i, pq j−1, i and j are integers. Thus, the scores in the successive columns are computed. In the last column (i=n−1, n is the number of audio segments), the maximal score S(T_{n-1,j}) represented as “correlating” score is extracted and trace backward until the first column (i=0). The path of synchronizing solution is found out. Then timeline construction unit 123 assigns the respective position and duration on a timeline for the visual segments, so as to generate media output 60 played in accordance with audio change. In an alternate embodiment, media output 60 is further rendered with the style information.

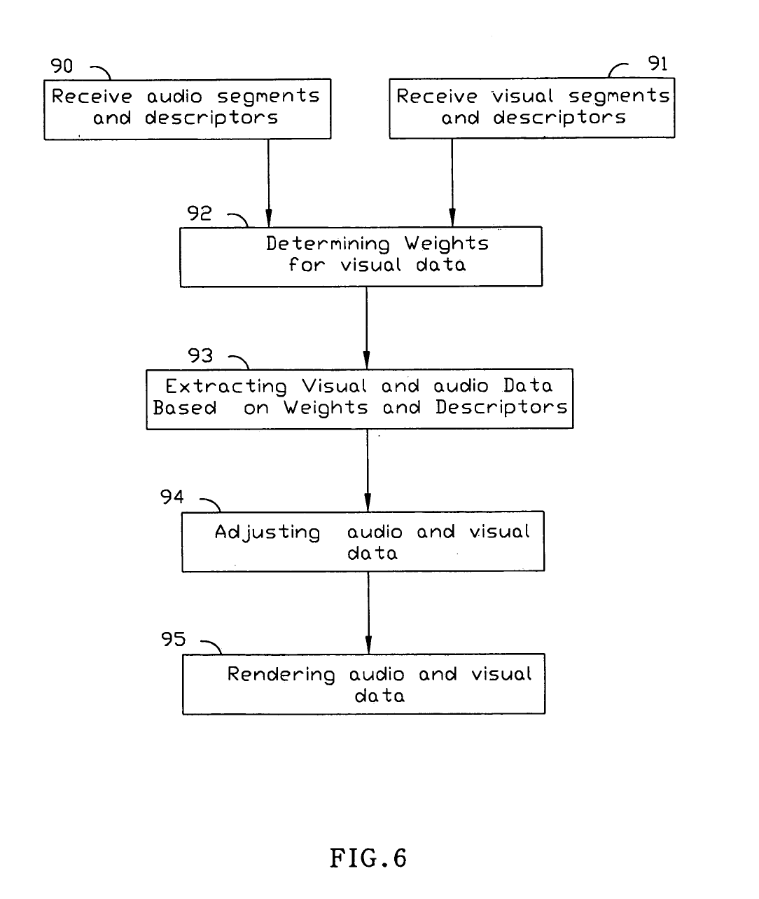

FIG. 6 is a schematic flow chart in accordance with FIG. 5. First, audio segments and descriptors (step 90), and visual segments and descriptors (step 91) are received. Next, determining the weights (step 92) for visual data, and a solution for correlating is found based on the determined weights. Then audio data and visual data are adjusted to generate a media output (step 94). Finally, the media output is rendered with other factors (step 95).

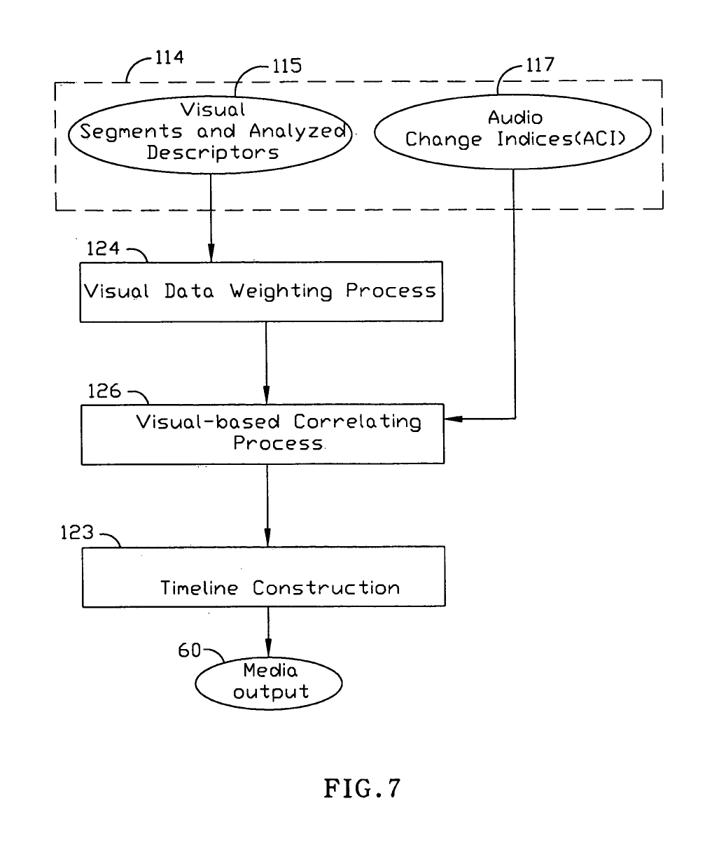

FIG. 7 is a schematic block diagram illustrating one embodiment of visual-based correlating process in accordance with the present invention. Refer to FIG. 7, analyzed data and descriptors 114 includes visual segments with analyzed descriptors 115 and audio change indices 117. Visual data weighting process 124 in weighting process 121, receives visual segments with analyzed descriptors 115 and calculates weights for each of visual segment on consideration of qualities, importance and preferences of visual segment. On the other hand, audio change indices 117 are generated by choosing significant audio signals with audio change. For example, a current audio signal compares with the set of previous audio signals and the audio change index records their difference. In other words, the audio change indices are also based on beat tracking or rhythm or tempo of audio signals.

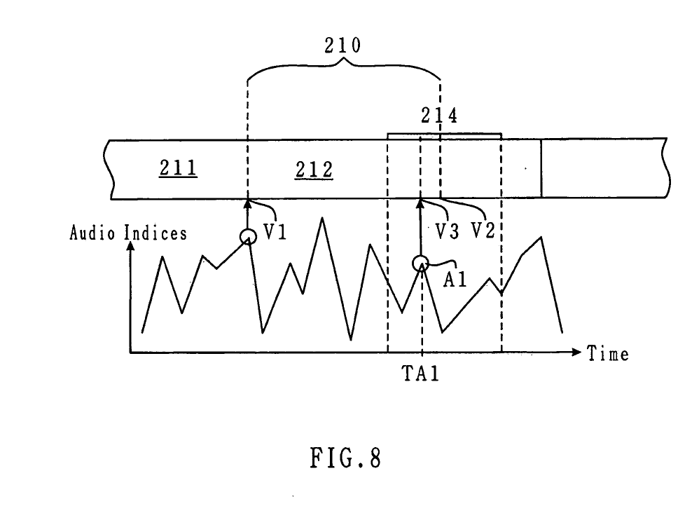

Next, for media output 60 played in accordance with visual change, visual-based correlating process 126 is selected. As shown in FIG. 8, firstly, estimate a preferred duration 210 for one current visual segment 212, and determine a searching window 214 based on the preferred duration 210. In one embodiment, the preferred duration 210 is around 8 seconds from point “v1” to “v2” corresponding to the current visual segment 212, and the searching window 214 is around 5 seconds covering the point “v2” corresponding to the current visual segment 212. In the embodiment, the point “v1” can be a beginning of the current visual segment 212 or an end of one previously correlated visual segment 211. However, they are not limited, the preferred duration 210 and size of the searching window 214 are adjustable depending on the designated duration for media output 60. Next, within the searching window 214, a local specific value “A1” of audio indices on audio input signal is extracted as a cutting point for visual segment, wherein the local specific value “A1” is higher than other values of other audio indices within the searching window 214 of corresponding visual segment 212. Then, based on a specific time “TA1” corresponding to local specific value “A1” of audio index, final duration of from point “v1” to “v3” of corresponding visual segment 212 is found out. Then timeline construction 123 automatically in sequence adjusts the visual segments with the corresponding final duration to generate media output 60 played in accordance with visual change. In an alternate embodiment, media output 60 is further rendered with the style information.

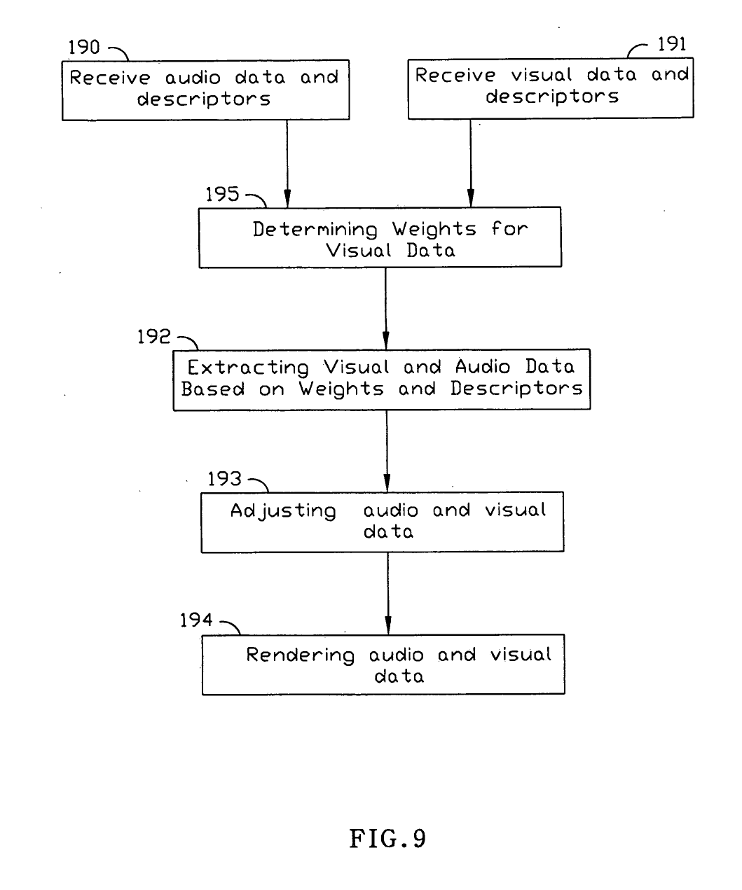

FIG. 9 is a schematic flow chart in accordance with FIG. 7. First, audio data and descriptors (step 190), and visual data and descriptors (step 191) are received. Next, determining the weights (step 195) for visual data, and a solution for correlating is found based on determined weights and index information of audio data (step 192). Then audio data and visual data are adjusted to generate a media output (step 193). Finally, the media output is rendered with other factors (step 194).

It will be clear to those skilled in the art that the invention can be embodied in many kinds of hardware device, including general-purpose computers, personal digital assistants, dedicated video-editing boxes, set-top boxes, digital video recorders, televisions, computer games consoles, digital still cameras, digital video cameras and other devices capable of media processing. It can also be embodied as a system comprising multiple devices, in which different parts of its functionality are embedded within more than one hardware device.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

1. A method of media editing, comprising:
receiving audio data and a plurality of associated audio descriptors, which describe characteristic of said audio data;
receiving visual data and a plurality of associated visual descriptors, which describe characteristic of said visual data;
determining a plurality of corresponding weights for said visual data;
correlating said audio data and said visual data based on said corresponding weights, said associated audio descriptors, and said associated visual descriptors; and
adjusting said audio data and said visual data to construct a media output.

2. The method of media editing according to claim 1, further comprising rendering said media output with style information.

3. The method of media editing according to claim 1, wherein the step of receiving audio data and said associated audio descriptors comprises:
receiving an audio signal; and
analyzing and segmenting said audio signal for generating said audio data and said associated audio descriptors, wherein said audio data consists of a plurality of audio segments.

4. The method of media editing according to claim 1, wherein the step of receiving visual data and said associated visual descriptors comprises receiving a plurality of visual segments and said associated visual descriptors.

5. The method of media editing according to claim 4, wherein the step of determining a plurality of corresponding weights comprises calculating any said corresponding weight for respective said visual segment.

6. The method of media editing according to claim 5, wherein the step of correlating comprises:
extracting an audio duration, from said associated audio descriptors, for respective said audio segment;
extracting a visual duration, from said associated visual descriptors, for respective said visual segment;
evaluating a plurality of correlating scores for respective sequences of said visual segments, based on said corresponding weights, said corresponding audio durations and said corresponding visual durations; and
finding a sequence of visual segments with a correlating score that is the maximal within said plurality of correlating scores.

7. The method of media editing according to claim 4, wherein the step of receiving audio data and said associated audio descriptors comprises:
receiving an audio signal; and
generating a plurality of audio indices by choosing said audio signal with audio change therein.

8. The method of media editing according to claim 7, wherein the step of correlating comprises:
finding a duration on each said visual segment;
determining a searching window based on said duration;
finding, within said searching window, a first index on said audio indices, wherein said first index is more than other indices on said audio indices within said searching window; and
adjusting each said visual segment, based on a time corresponding to said first index.

9. The production method of media output, comprising:
receiving audio segments and a plurality of associated audio descriptors, which describe characteristic of said audio segments;
receiving visual segments and a plurality of associated visual descriptors, which describe characteristic of said visual segments;
determining a plurality of corresponding weights for each said visual segment;
extracting a visual duration, from said associated visual descriptors, for each said visual segment;
extracting an audio duration, from said associated audio descriptors, for each said audio segment;
evaluating a plurality of correlating scores for respective sequences of said visual segments, based on said corresponding weights, said corresponding audio durations and said corresponding visual durations;
finding a sequence of visual segments with a correlating score that is the maximal within said plurality of correlating scores; and
adjusting said audio segments and said visual segments to generate a media output.

10. The production method of media output according to claim 9, further comprising rendering said media output with style information.

11. The production method of media output according to claim 9, wherein the step of receiving audio segments and associated audio descriptors comprises:
receiving an audio signal; and
analyzing and segmenting said audio signal for generating said audio segments and said associated audio descriptors.

12. The production method of media output according to claim 9, wherein the step of receiving visual segments and associated visual descriptors comprises:
receiving an video signal; and
analyzing and segmenting said video signal for generating said video segments and said associated visual descriptors.

13. The production method of media output according to claim 9, wherein said visual segments and said associated visual descriptors are in format of MPEG-7.

14. The production method of media output according to claim 9, wherein said audio segments and said associated audio descriptors are in format of MPEG-7.

15. The production method of media output, comprising:
receiving audio data and a plurality of associated audio descriptors, which describe characteristic of said audio data;
receiving visual data and a plurality of associated visual descriptors, which describe characteristic of said visual data;
finding, within a searching window, a value corresponding to said associated audio descriptors on said audio data, wherein said value is more than other value corresponding to associated audio descriptors within said searching window; and
adjusting said visual data, based on a time corresponding to said value, to generate a media output, wherein said media output is based on audio data and said adjusted visual data.

16. The production method of media output according to claim 15, further comprising rendering said media output with style information.

17. The production method of media output according to claim 15, wherein said visual data and said associated visual descriptors are in format of MPEG-7.

18. The production method of media output according to claim 15, wherein said audio data and said associated audio descriptors are in format of MPEG-7.

19. The production method of media output according to claim 15, wherein the step of receiving said audio data and said associated audio descriptors comprises:
receiving an audio signal; and
generating a plurality of audio indices by choosing said audio signal with audio change therein.

20. A storage device, storing a plurality of programs readable by a media process device, wherein the media process device according to said programs executes the steps comprising:
receiving audio data and a plurality of associated audio descriptors, which describe characteristic of said audio data;
receiving visual data and a plurality of associated visual descriptors, which describe characteristic of said visual data;
determining a plurality of corresponding weights for said visual data;
correlating said audio data and said visual data based on said corresponding weights, said associated audio descriptors, and said associated visual descriptors; and
adjusting said audio data and said visual data to construct a media output.

21. A storage device, storing a plurality of programs readable by a media process device, wherein the media process device according to said programs executes the steps comprising:
receiving audio segments and a plurality of associated audio descriptors, which describe characteristic of said audio segments;
receiving visual segments and a plurality of associated visual descriptors, which describe characteristic of said visual segments;
determining a corresponding weight for each said visual segment;
extracting a visual duration, from said associated visual descriptors, for each said visual segment;
extracting an audio duration, from said associated audio descriptors, for each said audio segment;
evaluating a plurality of correlating scores for respective sequences of said visual segments, based on said corresponding weights, said corresponding visual durations and said corresponding audio duration;
finding a sequence of visual segments with a correlating score that is the maximal within said plurality of correlating scores; and
adjusting said audio segments and said visual segments to generate a media output.

22. A storage device, storing a plurality of programs readable by a media process device, wherein the media process device according to said programs executes the steps comprising:
receiving audio data and a plurality of associated audio descriptors, which describe characteristic of said audio data;
receiving visual data and a plurality of associated visual descriptors, which describes characteristic of said visual data;
finding, within a searching window, a value corresponding to said associated audio descriptors on said audio data, wherein said value is more than other value corresponding to said associated audio descriptors within said searching window; and
adjusting said visual data, based on a time corresponding to said value, to generate a media output, wherein said media output is based on audio data and said adjusted visual data.
